(19) United States
(12) Patent Application Publication
(10) Pub. No.: US 2021/0054847 A1
(43) Pub. Date: Feb. 25, 2021

(54) METHOD AND APPARATUS TO PREDICT FAILURE AND CONTROL VIBRATIONS IN A SUBSURFACE ARTIFICIAL LIFT SYSTEM

(71) Applicant: PSI TECHNOLOGIES INC., Calgary, Alberta (CA)

(72) Inventors: Amir Badkoubeh, Calgary, Alberta (CA); Abbas Mahdi, Calgary, Alberta (CA); Chris Scrupa, Calgary, Alberta (CA)

(21) Appl. No.: 16/961,219

(22) PCT Filed: Jan. 7, 2019
(86) PCT No.: PCT/CA2019/050021

§ 371 Date: Jul. 9, 2020

(30) Foreign Application Priority Data
Jan. 10, 2018 (CA) 2,991,725

(51) Int. Cl. F04D 15/00; E21B 43/12

(52) U.S. Cl. CPC F04D 15/0066; F04B 49/065; E21B 43/128

(57) ABSTRACT

A monitoring and control apparatus communicates with an electrical drive of a subsurface artificial lift system to identify, predict and mitigate against failure of the artificial lift system. A monitoring and control apparatus: reads torque signals from the electrical drive or from a measurement device, produces a filtered torque signal; identifies frequency components of the filtered torque signal; compares the frequency components of the filtered torque signal with frequency components of a reference torque signal indicative of a healthy state of a pump motor of the artificial lift system to identify harmful frequencies in the filtered torque signal and generate a failure prediction index representing the likelihood of failure in comparison to a stable operation status; and then send a control signal to the electrical drive to adjust a frequency response of the pump motor so that the identified harmful frequency component is dampened.

### FIELD

This disclosure relates generally to an apparatus and method for predicting failure and controlling vibrations in a subsurface artificial lift system such as those utilized in mining, water and oil or gas wells.

### BACKGROUND

Artificial lift systems are commonly employed in subterranean wells to lift fluid from a subterranean reservoir to the surface, especially when reservoir pressure is low and the flow rate from the well is insufficient. There are several known types of artificial lift systems, including: gas lift systems which injects a gas into the well, and downhole pump systems which include electrical submersible pumps (ESP), progressive cavity pumps (PCP), hydraulic pumps, and rod pumps. Downhole pump-based artificial lift systems typically comprise downhole equipment including a pump and an electrical pump motor mechanically coupled to the pump, and surface equipment including an electrical drive, such as a variable speed drive, electrically coupled to the pump motor by a power cable to provide power to actuate the pump motor.

The electrical drive typically runs the downhole pump motor on a constant speed regardless of the efficiency and fluctuations on the torque due to downhole conditions. As such, the electrical drive acts as a pure reflector. In other words, the electrical drive reflects vibrations, including harmful vibrations, generated downhole. Such vibrations can expedite the degradation and breakage of the downhole equipment.

There are oil or gas artificial lift systems known to include monitoring and failure prediction apparatuses for electric submersible pumps that use downhole measurement devices for monitoring the operation of the downhole equipment. Such monitoring and failure prediction apparatuses tend to be expensive and prone to failure due to downhole communication noise and harsh downhole environment, as well as to degradation of electrical system integrity brought on by electrical transients.

It is therefore desirable to provide an improvement over prior art approaches to monitoring vibrations in artificial lift systems in oil or gas and other applications, and minimizing the effects of harmful vibrations.

### SUMMARY

According to one aspect of the invention, there is provided a method for predicting failure and controlling operation of an electrical drive of a pump motor in a subsurface artificial lift operation. The method comprises: receiving a raw torque signal read from the electrical drive, or estimated from a current of the pump motor, or measured directly from the pump motor; filtering noise components from the raw torque signal to produce a filtered torque signal; identifying frequency components of the filtered torque signal; comparing the frequency components of the filtered torque signal with frequency components of a reference torque signal indicative of a healthy state of the pump motor to identify a harmful frequency component; and then informing an operator of the harmful frequency component and/or sending a control signal to the electrical drive that adjusts a frequency response of the pump motor so that the identified harmful frequency component is dampened. The method can further comprise adjusting a reference speed of the drive motor to further dampen the identified harmful frequency component. The method can estimate the pump motor's rotational speed and shaft torque without external measurement sensors on the motor shaft. This feature is expected to be particularly beneficial in operations where it is difficult to install sensors.

The step of identifying frequency components of the filtered torque signal can comprise applying a form of Fourier Transform (e.g. Fast Fourier Transform (FFT), Short-Time Fourier Transform (STFT), Discrete Fourier Transform (DFT), Welch power spectral density) to the filtered torque signal. The step of filtering components from the raw torque signal can comprise applying a bandwidth filter that filters at least one of direct current torque, high frequency, and noise components from the raw torque signal.

The control signal that adjusts the frequency response of the electrical drive can comprise adjusting a proportional gain, an integration gain and optionally a derivative gain of the pump motor. The proportional gain and integration gain can be adjusted so that the frequency response of the pump motor is dissipative at the identified harmful frequency. The dissipative frequency response of the electrical drive can be defined by a reflection coefficient magnitude at the identified harmful frequency component that is less than 1. In particular, the reflection coefficient magnitude can be between 0.4 and 0.9.

According to another aspect of the invention, there is provided an apparatus for monitoring and controlling operation of an electrical drive of a pump motor in a subsurface artificial lift operation. The apparatus comprises: a processor communicative with the electrical drive to read a raw torque signal therefrom; a computer-readable memory having stored thereon program code executable by the processor to: (i) receive a raw torque signal read from the electrical drive, or estimated from a current of the pump motor, or measured directly from the pump motor; (ii) filter out noise components from the raw torque signal to produce a filtered torque signal; (iii) identify frequency components of the filtered torque signal; (iv) compare the frequency components of the filtered torque signal with frequency components of a reference torque signal indicative of a healthy state of the pump motor to identify a harmful frequency component; and (v) send a control signal to the electrical drive that adjusts a frequency response of the pump motor so that the identified harmful frequency component is dampened. The frequency components of the reference torque signal indicative of a healthy state can be stored on the computer readable memory. This apparatus can be a separate hardware module communicative with an electrical drive control unit, or may be embedded in the control unit.

### BRIEF DESCRIPTION OF DRAWINGS

FIG. 1 is a schematic diagram of a failure prediction and vibration control apparatus for use with a surface electrical drive of an artificial lift system, according to embodiments of the invention.

FIG. 2 is a functional block diagram of a control unit of the failure prediction and vibration control apparatus, configured to perform a fault detection operation, according to a first embodiment.

FIG. 3 is a flowchart of the fault detection operation.

FIG. 4 is a time-domain graph of a raw torque signal from the electrical drive received by a signal processor of the control unit.

FIG. 5 is a time-domain graph of a filtered torque signal from the electrical drive produced by the signal processor.

FIG. 6 is a reference time-frequency spectrum of an electrical drive in a healthy state stored in the control unit.

FIG. 7 is a time-frequency spectrum of the filtered torque signal from the electrical drive produced by the signal processor,

FIG. 8 is a failure index of the electrical drive produced by a fault detection module of the control unit.

FIG. 9 is a functional block diagram of the control unit of the failure prediction and vibration control apparatus, configured to perform a fault isolation and mitigation operation, according to a second embodiment.

FIG. 10 is a functional schematic of a fault isolation module of the control unit of the second embodiment of the failure prediction and vibration control apparatus.

FIG. 11 is a pump performance curve for a centrifugal pump, according to another embodiment.

FIG. 12 is a pump performance curve for a multistage centrifugal pump, showing the changes in system performance when a pressure valve in the artificial lift system is adjusted.

### DETAILED DESCRIPTION

Embodiments of the invention described herein relate generally to an apparatus and method for monitoring and controlling the operation of an electrical drive in a subsurface artificial lift system, in order to identify one or more harmful vibration frequencies in the system, predict a failure of one or more components of the artificial lift system caused by the harmful frequencies, and control vibrations in the system to mitigate against the failure. The artificial lift system comprises downhole equipment including a pump and a pump motor mechanically coupled to the pump, and surface equipment which includes the electrical drive. Alternatively, the pump motor may be located at surface. The electrical drive is electrically coupled (directly or indirectly) to the pump motor by an electrical cable. The pump can be one of a number of electrically powered pumps known in the art, including electric submersible pumps, progressive cavity pumps, and rod pumps. The electrical drive can comprise a variable speed drive (otherwise known as a variable frequency drive, adjustable frequency drive, AC drive, micro drive and inverter drive) known in the art. A vibration monitoring and control apparatus is located at surface, and is communicatively coupled to the electrical drive to receive a raw torque signal from the electrical drive and to send drive control signals to the electrical drive. In some embodiments, the vibration monitoring and control apparatus comprises a processor and a memory having encoded thereon a fault detection and failure mitigation program that is executable by the processor to perform a fault detection and failure mitigation operation comprising: reading the raw torque signal from the electrical drive; filtering noise components from the raw torque signal to produce a filtered torque signal; identify frequency components of the filtered torque signal; comparing the frequency components of the filtered torque signal with frequency components of a reference torque signal indicative of a healthy state of the motor to identify harmful frequencies in the filtered torque signal and generating a failure prediction index representing the likelihood of failure in comparison to a stable operation status; and then informing an operator of the failure likelihood and/or sending a control signal to the electrical drive to adjust a frequency response of the pump motor so that the identified harmful frequency component is dampened. In other embodiments, the vibration monitoring and control apparatus comprises a processor and a memory having encoded thereon a fault isolation and failure mitigation operation which is similar to the fault detection and failure mitigation operation, and differs by identifying the type of fault and its location by referencing the frequency components of signals related to the health of the system including the filtered torque signal with a database containing multiple possible fault scenarios.

The vibration monitoring and control apparatus predicts the state of the downhole equipment by real-time monitoring of the surface torque signal directly from the electrical drive. As such, the vibration monitoring and control apparatus does not require any separate downhole or surface sensors. Thus, the vibration monitoring and control apparatus is expected to be nonintrusive, robust and easy to deploy on operating artificial lift systems. The vibration monitoring and control apparatus is not only intended to monitor and predict the onset of failure in the artificial lift system but is also intended to take mitigating action to avoid or prolong the onset of failure caused by harmful vibrations, by causing the electrical drive to change its frequency response to dampen dominant harmful vibrations generated downhole; and to automatically adjust the pump motor speed set-point when a failure prediction index indicates a high likelihood of system failure. The vibration monitoring and control program can also be executed to adjust the power factor to mitigate power system harmful harmonics on the surface, thereby optimizing energy consumption and increasing the efficiency of system operation.

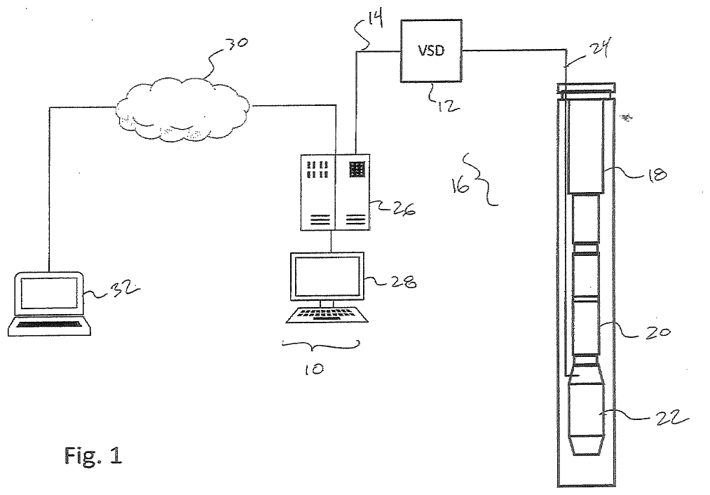

Referring now to FIG. 1 and according to a first embodiment, a vibration monitoring and control apparatus 10 programmed to carry out a fault detection and failure mitigation operation is electrically coupled to an electrical drive 12 by a communications cable 14. The electrical drive 12 comprises a variable speed drive (“VSD”) and is part of an artificial lift system 16, which comprises downhole equipment inserted into a production well (not shown). The downhole equipment includes a number of components attached to production tubing 18, including a pump 20 and a pump motor 22 mechanically coupled to the pump 20. The pump 20 in this embodiment is an electrically submersible pump, and alternatively can be another type of electrically driven pump known in the art such as a progressive cavity pump, a hydraulic pump, and a rod pump. A power cable 24 extends from the VSD 12 and into the well to couple to the pump motor 22.

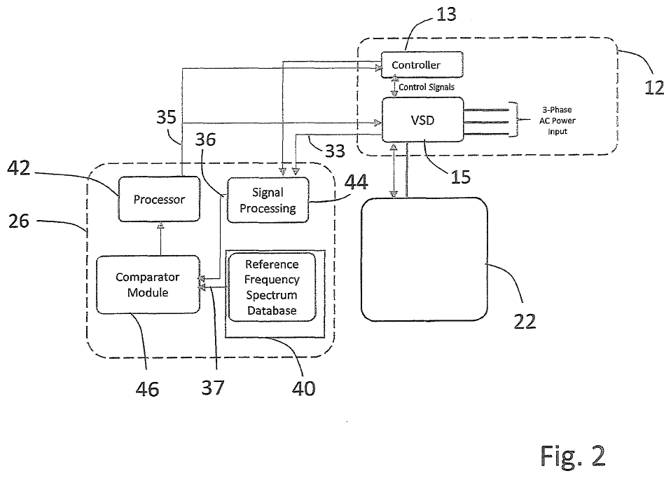

The electrical drive 12 comprises a controller 13 and a VSD 15 (see FIG. 2) that can vary the speed of the pump motor 22 by sending control signals to the pump motor 22 that vary motor input frequency and voltage. The pump motor 22 in this embodiment is an AC three phase induction electric motor; however other types of electric motors known in the art can also be used, e.g. synchronous motors. The electrical drive controller 13 in this embodiment is a solid state power controller well known in the art, such as a PID controller, and thus is not described in detail here. VSDs may utilize one of several control mechanisms for adjusting the output frequency, such as: Volts/Hz, sensorless vector control, flux vector control and field-oriented control.

The vibration monitoring and control apparatus 10 comprises a control unit 26 and a local input/output terminal 28 electrically communicative with the control unit 26, and having stored thereon the fault detection and failure mitigation program. Alternatively, the monitoring and control program can be integrated into the existing controller 13 of the electrical drive 12. The local terminal 28 includes a display screen for an operator to monitor the operation of the apparatus 10, and networking equipment for transferring data to and from a remote storage, such as a cloud platform 30, for access by remote terminals 32. Referring now to FIG. 2, the control unit 26 includes a local data storage device 40, such as a solid state or hard drive, for storing data including reference frequency spectrums indicative of healthy states. Alternatively, the reference frequency spectrums can be stored in a data storage device in a remote location and accessed by the control unit 26 via a network (not shown). The control unit 26 also includes a processor 42 that executes the monitoring and control program (which can be stored in the memory of the processor, or on the data storage device 40), and which can access the reference frequency spectrums stored in the data storage device 40, receive torque signal data 33 from the electrical drive 12, and send control signals 35 to the electrical drive 12.

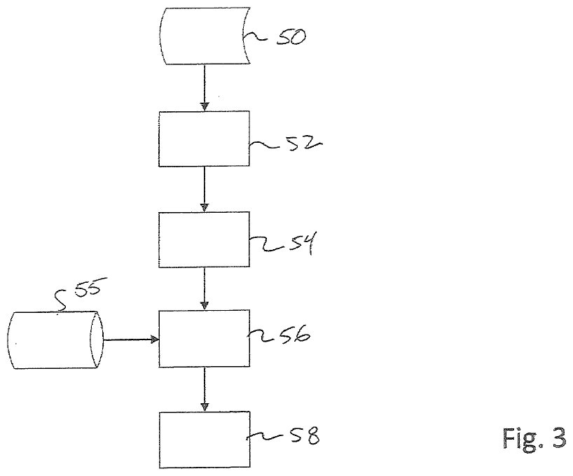

Referring to FIGS. 2 and 3, the fault detection and failure mitigation program comprises program code which when executed will read torque signals from the electrical drive 12, identify harmful frequency components in the torque signals 33 that may negatively affect the performance and/or longevity of the artificial lift system 16, and adjust operation of the electrical drive 12 such that the harmful frequency components are dampened.

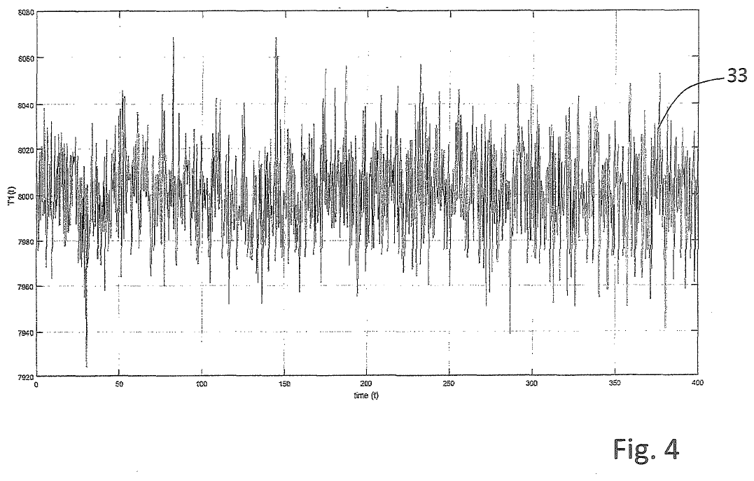

Referring to FIGS. 2 to 4, a signal processing module 44 of the control unit 26 first reads samples of a real-time raw torque signal 33 from the electrical drive 12 indicative of a current operating state of the artificial lift system 12; the read torque signal samples 33 are collected and stored in a first input first output (FIFO) buffer (step 50 of FIG. 3). In this embodiment, the length of the buffer is 10 times larger than the largest period of the signal; however the buffer length can be varied according to different embodiments.

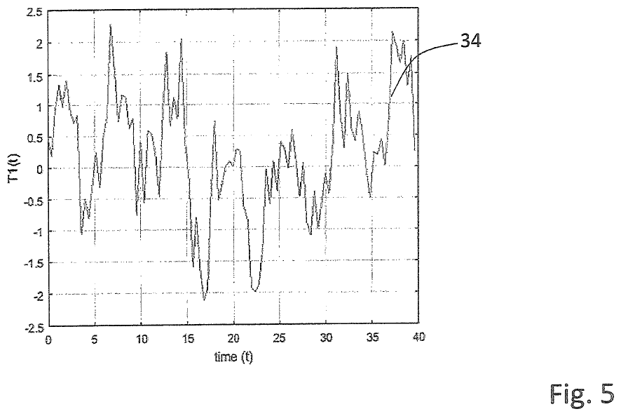

Referring to FIGS. 2 to 5, a filtering operation is then performed by the signal processing module 44 which includes applying a bandwidth filter to the raw torque signal samples 33 to filter out undesired components in the raw torque signal samples, thereby producing filtered torque signal samples 34 (“measured frequency spectrum”) (step 52). In this embodiment, the bandwidth filter is configured to filter out DC torque components, high and low frequency components, and noise components; in other embodiments, the bandwidth filter can be configured to filter out different components or a different subset of these components.

Referring to FIGS. 2 to 5, a frequency detection operation is performed which includes applying a form of Fourier transform (e.g. FFT, DFT, STFT, Wlech power spectrum) to the filtered torque signal samples 34 to produce a measured frequency spectrum to detect the frequency components of the measured frequency spectrum (step 54). A comparator module 46 of the control unit 26 performs a comparison operation which includes retrieving a reference frequency spectrum stored on the local storage device 40 indicative of a healthy state of the artificial lift system (“reference healthy frequency spectrums”) (step 55). The reference healthy frequency spectrum is compared to the measured frequency spectrum, thereby identifying harmful frequency components f_{H} (step 56) in the measured frequency spectrum. These harmful frequencies f_{H} represent harmful vibrations that are generated downhole and propagate to the electrical drive 12 at surface. These harmful vibrations may lead to eventual or imminent failure in the artificial lift system.

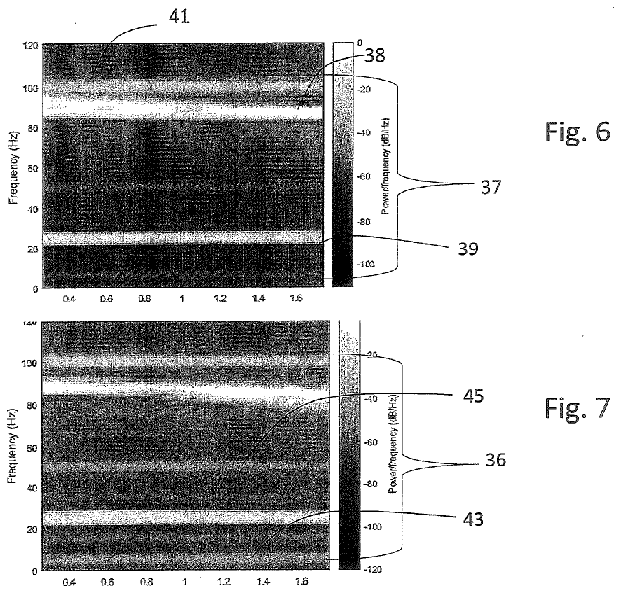

An example of the measured frequency spectrum 36 is shown in FIG. 7 and an example of the reference frequency spectrum 37 is shown in FIG. 6. A healthy state can be defined based on heuristic knowledge of operators or by previously measured operating states that were known to be healthy (e.g. measured from artificial lift systems installed in other wells with similar operating conditions), and can be detected and registered at the operation site, by storing on the data storage device 40 or on the local terminal 28. The reference frequency spectrum 37 has a power spectral density of the torque signal depicted by the intensity of the color (black to white); the frequency content (y-axis) plotted against a monotone variable such as time (minutes) or Net Positive Suction Head ratio (NPSH) of the pump. Ordinarily, the healthy state frequency spectrum comprises three main components: the frequency where the energy of the shaft torque signal concentrated 38 (which is generated by the mechanical interaction of the pumps and the rotational speed) at around 90 Hz in this example, the frequency of rotational speed 39, at around 25 Hz in this particular example, and blade pass frequency 41, at around 100 Hz in this particular example (four times the frequency of rotational speed in this particular example). In contrast, the most notable deviation in the measured frequency spectrum 36 from the healthy state 37 is the increase in the magnitude of blade pass frequency decrease in the shaft torque magnitude around the rotational speed frequency, a magnified low frequency component 43 (around 1-5 Hz), and a shaft torque component 45 at the first harmonic of the rotational speed (i.e. at 50 Hz). The magnified low frequency component 43 and shaft torque component 45 represent the harmful frequencies f_{H} and increase in blade pass frequency magnitude.

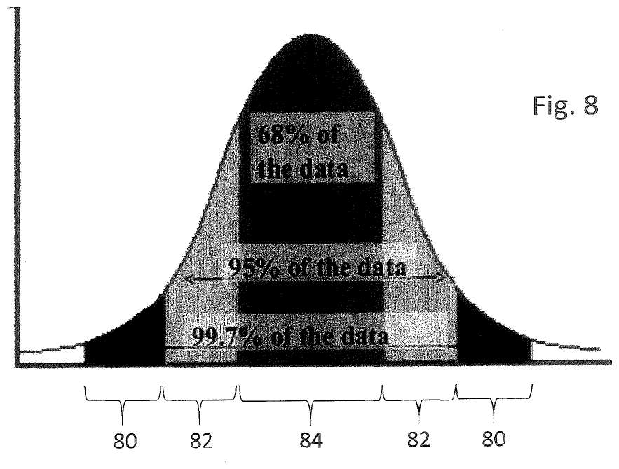

Referring now to FIG. 8, a Failure Index is constructed that associates the identified harmful frequencies in the measured frequency spectrum with the healthy reference frequency spectrum to predict whether the current operational condition of the artificial lift system 16 will result in system failure. The Failure Index quantifies the correlation (or deviation) of the current time-frequency spectrum of the torque signal to (or from) that of healthy state. This index informs the well operator (or well field manager) whether something is wrong in the system. The Failure Index is generated using an algorithm which uses the spectral coherence (also known as magnitude-squared coherence) to compare the measured frequency spectrum 36 (“Y”) with the reference healthy spectrum 37 (“X”) to generate the Failure Index (FI). As such, the FI is defined as follows:

$$FI = 100 \times \frac{{\vert {G}_{xy} \vert}^{2}}{\vert {G}_{xx} \vert \vert {G}_{yy} \vert} \qquad ( equation 1 )$$

wherein |G_{xy}| is the magnitude cross-spectral density between the measured and reference frequency spectrums X and Y, and |Gₓₓ| and |G_{yy}| are the auto-spectral density of the measured and reference frequency spectrums X and Y respectively. FI is always between 0 and 100, wherein when FI equals 100 both signal are fully matched and when FI equals 0 there is no coherence between the two signals. When FI is higher than 95% the artificial lift system is considered to be in a healthy condition (“healthy condition” 80). When FI is between 68% and 95%, the harmful vibration frequencies in the measured frequency spectrum are expected to cause terminal damage if not mitigated within a period of time (“alarm condition” 82). When FI is less than 68%, the harmful frequency vibrations in the measured frequency spectrum are expected to inevitably cause failure (“failure condition” 84).

As noted above, prior art speed control in electrical drives for downhole motor pumps are relatively stiff. As such, they act as a pure reflector for all frequencies generated in a load, including harmful frequencies. To mitigate against failure caused by the harmful frequencies, the fault detection and failure mitigation program according to the present embodiment generates a control signal 35 that contains instructions to the electrical drive 12 to adjust certain operational parameters of the pump motor 22 to dampen the harmful frequency f_{H}, when the Failure Index indicates an alarm condition 82 or a failure condition 84 (step 58). When the Failure Index indicates a healthy condition 80, the electrical drive monitoring and control apparatus 10 does not need to take any corrective action.

More particularly, the fault detection and failure mitigation program sends a control signal 35 to the electrical drive 12 that adjusts the proportional gain Kₚ and integration gain Kᵢ of the pump motor 22, and if necessary, adjusts the reference speed Ω_{Set} of the pump motor 22. The fault detection and failure mitigation program determines Kₚ, Kᵢ and Ω_{Set} using an algorithm that is based on an equation of motion for an AC driven artificial lift system:

$${J}_{pump} \frac{d Ω}{dt} + Kp ( {Ω}_{set} - Ω ) + {K}_{I} \int ( {Ω}_{set} - Ω ) = {T}_{load} \qquad ( a )$$

where Ω_{Set}, Ω (rad/Sec²) are the reference speed and the delivered speed respectively; Jₚᵤₘₚ (kg·m²) is the system inertia; Kₚ and Kᵢ represent, respectively, the proportional gain and the integration gain of the electrical drive (e.g. PI-controller), and T_{load} is the mechanical torque generated in the load.

In the embodiments where the electrical drive 12 is a PID controller, a new term

$${K}_{D} \frac{d ( {Ω}_{Set} - Ω )}{dt}$$

may be added to the equation where K_{D} is the derivative gain of the electrical drive 12. As the derivative term is highly sensitive to measurement noise, the derivative term may be set to zero.

To determine Kₚ and Kᵢ, the fault detection and failure mitigation program uses a parameter called reflection coefficient. In a method well understood in the art (such as described in Shive J. N. (1961), Similarities in Wave Behavior, Bell Telephone Laboratory), the reflection coefficient, D, between a generator and a load in frequency domain is defined as:

$$D ( ω ) = \frac{H ( ω ) - Z ( ω )}{H ( ω ) + Z ( ω )} \qquad ( b )$$

where H is the characteristic impedance of the load and Z is the characteristic impedance of the generator and ω=2πf (Rad/Sec) is the angular frequency. The value for H can be determined from the specifications of the pump motor 22 and describes the relationship between the impeller torque and the angular speed of the impeller. This relationship is well understood in the art (such as described in Kallesrøe, C. (2006) Fault Detection and Isolation in Centrifugal Pumps. Aalborg Universitet Denmark) and the value for Z can be determined from the equation (c) below. A reflection coefficient magnitude, |D(f)|, less than one represents an energy loss or a dissipative system.

The fault detection and failure mitigation program solves equation (b) at the harmful frequency, ω_{H}=2πf_{H}, to obtain 0.4<|D(ω_{H})|<0.9. The impedance of the generator in frequency domain may be written:

$$Z = i ω {J}_{pump} + {K}_{P} + \frac{{K}_{i}}{i ω} \qquad ( c )$$

where Jₚᵤₘₚ (kg·m²) is the system inertia, Kₚ and Kᵢ represent, respectively, the proportional gain and the integration gain of the electrical drive (e.g. PI-controller) and i=\sqrt{−1} is the imaginary unit. By substituting Z and a characteristic impedance for the load, H, derived from its equivalent mechanical model, Kₚ and Kᵢ may be directly calculated to have 0.4<|D(ω_{H})|<0.9. By adjusting the proportional gain and the integration gain of the electrical drive 12 with these calculated values, the resulting harmful frequency will be contained within a range wherein the energy in the system is dissipative.

To determine the reference speed Ω_{Set}, the fault detection and failure mitigation program sets the reference speed, Ω_{Set} at a value that causes the pump motor 22 to operate in a range that provides the highest dampening for the harmful frequency, albeit at reduction in pump performance index (PPD. Pump performance index is a metric that can be broadly defined; one example of PPI compares actual production rate vs design production rate as follows:

PPI=100×Q_{Actual}/Q_{Design}

After the proportional gain Kₚ, integration gain Kᵢ, and the reference speed Ω_{Set} are determined, the fault detection and failure mitigation program mitigates the harmful frequency f_{H}, by first sending a control signal 35 which adjusts Kₚ and Kᵢ to cause 0.4<|D(ω_{H})|<0.9. The torque signal 33 from the electrical drive 12 is then read and the FI generated, according to the previously descried steps. If the FI for the read torque signal is still in an alarm or failure condition 82, 84, then the fault detection and failure mitigation program sends a subsequent control signal 35 which adjusts Ω_{Set} to reduce the likelihood of failure, albeit at a reduced pump performance. The parameter Ω_{Set} can be adjusted up to the minimum limit of the operating envelope of the artificial lift system 16 as defined by the operator.

After the monitoring and control apparatus 10 sends the control signal 35 to the electrical drive 12 containing the adjusted operating parameters, the fluctuations on the pump motor torque are expected to be significantly reduced. This indicates that the downhole equipment 16 experiences much less vibration and electrical and mechanical fatigue than prior to the operating parameter adjustment. Furthermore, this smoother operation may result in less power consumption. Furthermore, by dampening harmful vibrations, the monitoring and control apparatus 10 also results in beneficially adjusting the power factor to mitigate harmful harmonics on the power networks.

When the Failure Index shows a failure condition indicating an imminent failure of the artificial lift system 16, the monitoring and control apparatus 10 can inform an operator of the predicted failure and allow the operator to take manual action, or, the monitoring and control apparatus 10 can automatically adjust the operational speed, or operational frequency, of the pump motor 22 to as low as feasible within the pump's operating range. This adjustment of the operational speed is expected to delay the onset of catastrophic failure so that remedial pump replacement can be planned in advance rather than reactive to pump system failure.

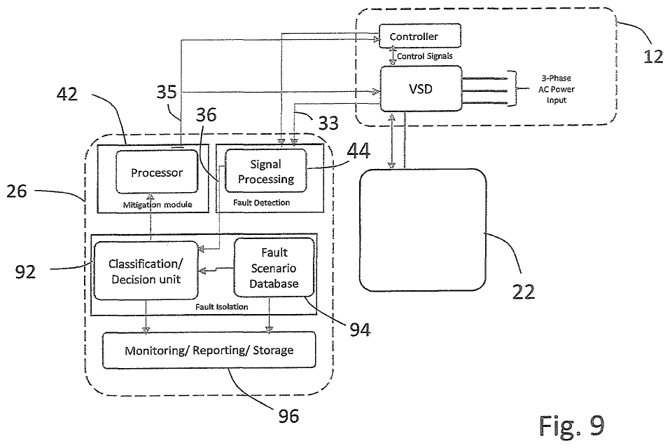

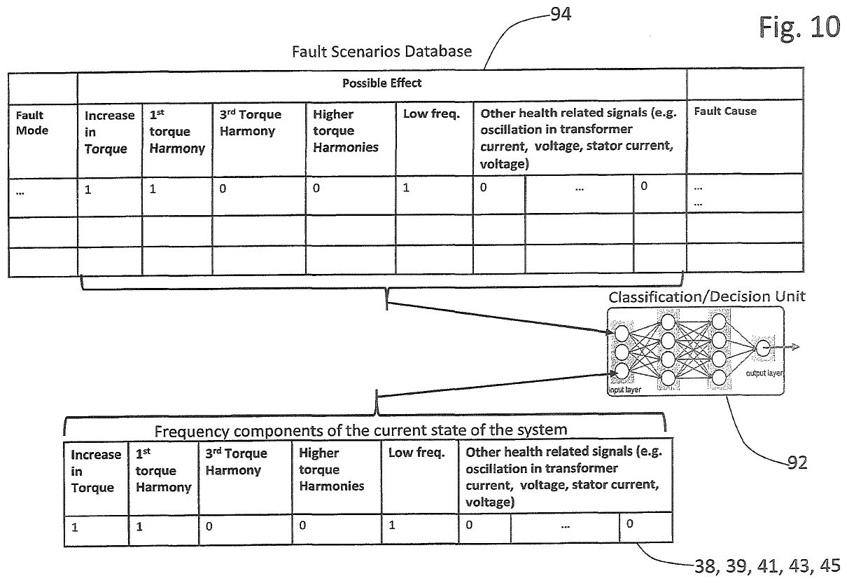

According to another embodiment, and referring to FIGS. 9 and 10, the monitoring and control apparatus 10 further comprises a fault isolation and failure mitigation program executable by the processor to carry out a fault isolation and failure mitigation operation. As noted above, the fault isolation and mitigation operation is similar to the fault detection and mitigation operation, and differs by identifying the type of fault and its location by referencing the frequency components of the filtered torque signal with a database containing multiple possible fault scenarios.

Similar to the first embodiment, the monitoring and control apparatus 10 comprises a control unit 26 having stored thereon the fault detection and mitigation program. However, the controller 26 further comprises a fault isolation program module for performing the fault isolation operation, which compares the current state of the system with an existing fault scenario database which indicates the fault mode and the fault causes. The output of the fault isolation program module informs the well operator (or well field manager) what is the possible type of fault and the possible causes. In operation, the signal processor 44 reads samples of the real-time raw torque signal 33 from the electrical drive 12 and performs a filtering operation and a frequency detection operation in the same manner as the first embodiment, to output the measured frequency spectrum 36 with frequency components 38, 39, 41, 43, 45. The measured frequency spectrum 36 is then sent to a classification I decision unit 92, which compares the measured frequency spectrum 36 with predefined data sets from a fault scenario database 94 stored the local storage device 40. The fault scenario database 94 comprises possible faults and their causes in the system; the fault scenario database 94 can be constructed in accordance with known fault scenario databases in pump systems, such as those found in Kallesøe, C. (2006). Fault Detection and Isolation in Centrifugal Pumps. Aalborg Universitet Denmark.

Each data set in the fault scenario database 94 describes characteristics of a given fault in the system. When a match is found, a reporting module 96 can generate a report identifying the type of fault and its causes. Once the fault type and causes is determined, the processor 42 can take action including sending a control signal 35 to adjust the electrical drive 12 operation using the technique of impedance matching to adjust the dampening of the system around the harmful frequency as is carried out in the first embodiment. Alternatively or additionally, a user can take other corrective action, such as going to the source of the fault, and correcting the fault directly using the report generated by the reporting unit 96.

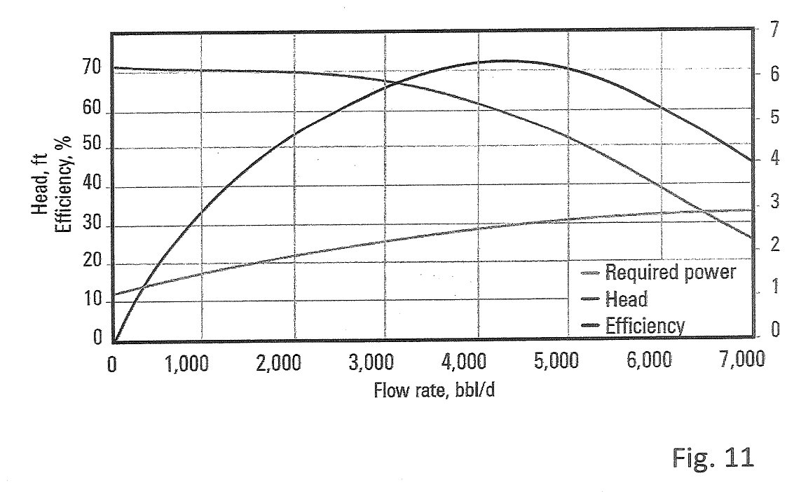

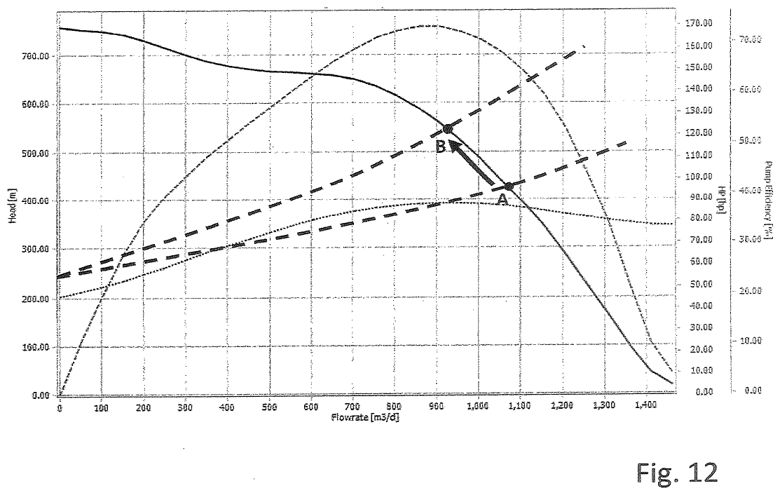

Referring to FIGS. 11 and 12 and according to an alternative embodiment, the monitoring and control apparatus 10 can also send a control signal to an actuator to adjust a control valve in the production system (not shown) so that the pressure output of the artificial lift system is adjusted to minimize harmful frequency components. For a centrifugal pump, this typically corresponds with the published best efficiency point, but may differ due to manufacturing tolerances, rheological characteristics of the fluid being produced which may or may not be transient in nature and mechanical wear and tear. For example, in FIG. 11 a manufacturer's pump performance curve is shown for a single pump stage which shows the head, power and efficiency characteristic curves for the pump, with the shaded area being the pump's recommended operating range. In FIG. 12, a pump performance curve is shown for a multistage centrifugal pump showing an increase in system pressure caused by adjusting a valve in the discharge of the production. This shifts the system curve and operating point from A to B.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible. It will be clear to any person skilled in the art that modifications of and adjustments to this invention, not shown, are possible as demonstrated through the exemplary embodiment.

What is claimed is:

1. A method for monitoring and controlling operation of an electrical drive of a pump motor in an artificial lift operation, comprising:
(a) receiving a raw torque signal, wherein the raw torque signal is read from the electrical drive or estimated from a current of the pump motor, or directly measured from the pump motor;
(b) filtering out noise components from the raw torque signal to produce a filtered torque signal;
(c) identifying frequency components of the filtered torque signal;
(d) comparing the frequency components of the filtered torque signal with frequency components of a reference torque signal indicative of a healthy state of the pump motor to identify a harmful frequency component; and
(e) sending a control signal to the electrical drive that adjusts a frequency response of the pump motor so that the identified harmful frequency component is dampened.

2. A method as claimed in claim 1, wherein the step of identifying frequency components of the filtered torque signal comprises applying a Fourier Transform to the filtered torque signal.

3. A method as claimed in claim 1 wherein the step of filtering components from the raw torque signal comprises applying a bandwidth filter that filters at least one of direct current torque, high frequency, and noise components from the raw torque signal.

4. A method as claimed in claim 1, further comprising comparing a measured frequency spectrum of the filtered torque signal with a reference healthy spectrum of the reference torque signal to generate a failure index (FI), and predicting a likelihood of failure based on a failure index value.

5. A method as claimed in claim 1 wherein the control signal that adjusts the frequency response of the electrical drive comprises adjusting a proportional gain, an integration gain and optionally a derivative gain of the pump motor.

6. A method as claimed in claim 5, wherein the proportional gain and integration gain is adjusted so that the frequency response of the pump motor is dissipative at the identified harmful frequency.

7. A method as claimed in claim 6, wherein the dissipative frequency response of the electrical drive is defined by a reflection coefficient magnitude at the identified harmful frequency component that is less than 1.

8. A method as claimed in claim 1 further comprising sending a control signal to adjust a reference speed of the drive motor to further dampen the identified harmful frequency component.

9. A method as claimed in claim 1 further comprising sending a control signal to adjust a pressure valve actuator in the discharge of the production so that a system pressure approaches a pump head value at maximum pump efficiency.

10. A method as claimed in claim 1 further comprising (f) comparing the frequency components of the filtered torque signal with predefined data sets in a fault scenario database indicating types and causes of faults associated with different frequency components, and generating a user report identifying a type and cause of a fault associated with the raw torque signal.

11. An apparatus for monitoring and controlling operation of an electrical drive of a pump motor in an artificial lift operation, comprising:
(a) a processor communicative with the electrical drive to read a raw torque signal therefrom;
(b) a computer-readable memory having stored thereon program code executable by the processor to:
(i) read a raw torque signal from the electrical drive or estimate a raw torque signal from motor current, or directly measure the raw torque signal;
(ii) filter out noise components from the raw torque signal to produce a filtered torque signal;
(iii) identify frequency components of the filtered torque signal;
(iv) comparing the frequency components of the filtered torque signal with frequency components of a reference torque signal indicative of a healthy state of the pump motor to identify a harmful frequency component; and
(v) send a control signal to the electrical drive that adjusts a frequency response of the pump motor so that the identified harmful frequency component is dampened.

12. The apparatus as claimed in claim 11 wherein the frequency components of the reference torque signal indicative of a healthy state are stored on the computer readable memory.

13. The apparatus as claimed in claim 12 wherein the steps for monitoring and controlling operation is executed and stored on a storage device.

14. The apparatus as claimed in claim 11 wherein the memory further comprises program code executable by the processor to (v) compare the frequency components of the filtered torque signal with predefined data sets in a fault scenario database indicating types and causes of faults associated with different frequency components, and generate a user report identifying a type and cause of a fault associated with the raw torque signal.
